(19) United States
(12) Patent Application Publication
(10) Pub. No.: US 2026/0129394 A1
(43) Pub. Date: May 7, 2026

(54) HEIGHT AUDIO ADJUSTMENT BASED ON LISTENING ENVIRONMENT CHARACTERISTICS

(71) Applicant: Sonos, Inc., Goleta, CA (US)

(72) Inventors: Daniel Jones, London (GB); Adib Mehrabi, London (GB); Paul Peace, Boston, MA (US); Briet Louise Brown, Boston, MA (US)

(21) Appl. No.: 19/435,416

(22) Filed: Dec. 29, 2025

Related U.S. Application Data
(63) Continuation of application No. PCT/US2024/037012, filed on Jul. 8, 2024.
(60) Provisional application No. 63/512,838, filed on Jul. 10, 2023.
(60) Provisional application No. 63/512,843, filed on Jul. 10, 2023.

(51) Int. Cl. H04S 7/00; H04R 3/14; H04R 5/02

(52) U.S. Cl. CPC H04S 7/301; H04R 3/14; H04R 5/02; H04S 2400/11; H04S 2400/15

(57) ABSTRACT

An example media playback system includes an upward-firing transducer and a horizontal-firing transducer in a playback device and a microphone that is horizontally spaced apart from the upward-firing transducer. The media playback system is configured to output a first audio signal from the upward-firing transducer and a second audio signal from the horizontal-firing transducer, receive a reflection of the first audio signal from a ceiling of a listening environment at the microphone, receive the second audio signal at the microphone, determine a distance between the playback device and the microphone based on the second audio signal, and determine a ceiling characteristic based on the reflection of the first audio signal and the distance between the playback device and the microphone.

### CROSS-REFERENCE TO RELATED APPLICATIONS

This application is a continuation of International Application No. PCT/US2024/037012, filed Jul. 8, 2024, which claims the benefit of priority to U.S. Patent Application No. 63/512,838, filed Jul. 10, 2023, and to U.S. Patent Application No. 63/512,843, filed Jul. 10, 2023, each of which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, examples, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with examples of the present technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2A is a front isometric view of a playback device configured in accordance with examples of the present technology.

FIG. 2B is a front isometric view of the playback device of FIG. 3A without a grille.

FIG. 2C is an exploded view of the playback device of FIG. 2A.

FIG. 3A is a perspective view of a playback device configured in accordance with examples of the present technology.

FIG. 3B is a transparent view of the playback device of FIG. 3A illustrating individual transducers.

FIGS. 4A, 4B, 4C, and 4D are diagrams showing an example playback device configuration in accordance with examples of the present technology.

FIG. 5 is a diagram showing an example media playback system in accordance with examples of the present technology.

FIG. 6 is a flow diagram of a method for determining a ceiling characteristic in accordance with examples of the present technology.

FIG. 7 is a diagram showing an example media playback system in accordance with examples of the present technology.

FIG. 8 is a flow diagram of a method for adjusting audio output parameter(s) based on a ceiling characteristic in accordance with examples of the present technology.

### DETAILED DESCRIPTION

### I. Overview

Three-dimensional (3D) and other immersive spatial audio rendering formats may include one or more channels that represent sound intended to be perceived by a listener as originating from above their listening position. These channels may be referred to as vertical or height audio channels or components. Height audio channels, along with lateral audio channels, (e.g., those that the listener perceives as arriving from the left, right, front or behind), form part of an audio output reproduced by a media playback system including one or more playback devices. As part of such multichannel audio playback, height audio channels enable a greater variety in the type of soundscape that can be delivered, and provide an even more immersive experience to a listener. Examples of 3D audio formats include DOLBY ATMOS, MPEG-H, and DTS: X formats. Such 3D or other immersive audio formats may be used with music or video content.

Traditionally, immersive audio, such as surround sound and 3D audio formats, has been reserved for movie theaters and high-specification home theater setups, where the conditions of the listening environment can be tightly controlled and precisely designed by acoustic consultants. Such setups may make use of ceiling-or wall-mounted playback devices or transducers to reproduce height audio channels by reproducing the height audio channels from above the listener, but these transducers require careful positioning to ensure that height audio is correctly delivered to a listener, and are costly and inconvenient to install and to move once installed. Moreover, ceiling-mounted devices, particularly in-ceiling speakers, tend to be relatively directional and thus several individual devices may be necessary to provide sufficient height audio coverage for a listening area. As an alternative, some playback devices incorporate so-called “up-firing” or “upward-firing” transducers. Upward-firing transducers, which may be referred to as vertical transducers, vertical-facing transducers, upfiring transducers, upwardly-oriented transducers, height transducers, top audio transducers, or a combination of these terms, may be incorporated into playback devices that are expected to be positioned at a similar height to the listener. For example, a soundbar may incorporate an upward-firing transducer and may be mounted beneath a television or on a credenza. Other devices incorporating upward-firing transducers, which may be multi-transducer devices also incorporating horizontal-firing transducers, may be freestanding and positioned on a floor of a listening environment, or mounted on shelves or stands. In these devices, the upward-firing transducers may be oriented at an upward oblique angle (e.g., 70 degrees above horizontal), such that they can output audio along a sound axis that is at least partially vertically oriented with respect to a forward horizontal plane of the device. This audio output can reflect off an acoustically reflective surface (e.g., a ceiling) to be directed toward a listener at a target location. The listener perceives height audio from the upward firing transducers as originating from a point or region of reflection on the ceiling, and so interprets the audio as originating “above” herself.

Playback devices including upward-firing transducers are commonly designed to operate in the sort of tightly controlled home theatre setups described above. Media playback systems reproducing 3D audio typically provide a “sweet spot”, which is a location within the listening environment at which a listener perceives the best listening experience. The sweet spot can occupy a relatively small region within the listening environment, even when the environment is optimized for audio playback. For example, if a first listener is positioned in the sweet spot, a second listener positioned 2 m to the left or right of the first listener may have a suboptimal, or at least substantially different, listening experience to the first listener. However, where a media playback system is provided in environments that have not been so precisely designed, the listening experience may suffer. This is particularly the case where listening environments such as living rooms may have ceilings with non-uniform characteristics and where devices may be positioned different distances from a listener. For example, a ceiling may have a non-flat and/or non-level profile (e.g., it may be a slanted, pitched, barrel, coffered or multi-level, or coved) and/or may be more absorptive and/or diffusive than a typical drywall ceiling.

The techniques described herein enable the characterization of the ceiling using a playback device incorporating an upward-firing transducer so that height audio reproduction may be tuned to the listening environment. The techniques described herein also provide said tuning of the height audio reproduction by adjusting audio content between transducers of playback devices within the listening environment, dependent on determined ceiling characteristics. As a result, height audio reproduction may be improved for different ceiling types, profiles, etc. Such improvements may enable height audio reproduction where previous height audio techniques may have produced suboptimal results. Improving height audio reproduction may lead to a more enjoyable and immersive listener experience.

To enable height audio channels to be reproduced to provide a good listening experience to a listener, it may be useful to characterize a ceiling or ceiling portion of a listening environment. According to some aspects of the invention, there is provided a method for determining a ceiling characteristic. The method comprises: outputting, from a first upward-firing transducer at a first playback device, one or more first audio signals; receiving, at one or more microphones that are horizontally spaced apart from the first upward-firing transducer, a reflection of the one or more first audio signal from a ceiling of a listening environment in which the first playback device and the one or more microphones are positioned; outputting, from a first horizontal-firing transducer at the first playback device, one or more second audio signals; receiving the one or more second audio signals at the one or more microphones; determining a distance between the first playback device and the one or more microphones based on the one or more second audio signals; and determining, based on the reflection of the one or more first audio signals and the distance between the first playback device and the one or more microphone, a ceiling characteristic.

There is provided, according to another aspect of the invention, a media playback system for executing the method described herein. The media playback system comprises the first upward-firing transducer and a first horizontal-firing transducer in a first playback device, and one or more microphones that are horizontally spaced apart from the first upward-firing transducer. The media playback system further includes one or more processors and memory storing instructions for execution by the one or more processors. The instructions, when executed by the one or more processors, cause the media playback system to perform the steps of the above-described method.

Using the above method or media playback system, at least one characteristic of a ceiling of a listening environment may be determined. The method enables a playback device to be used to determine a ceiling characteristic of at least part of the ceiling. In other words, characteristics of a ceiling, which may be useful in determining how to playback audio signals including height audio components, may be determined using audio. This may allow characterization of the ceiling using the same equipment as will eventually be used to playback audio, and avoids requiring additional audio equipment, such as an omnidirectional sound source and/or a highly directional sound source. Moreover, the playback device can be positioned at a position in which it will be used to playback audio, and the ceiling characteristic determined for a portion of the ceiling between it and a listener location.

Having knowledge of the distance between the first playback device and the one or more microphones as well as measuring reflections from the ceiling improves the accuracy with which a ceiling characteristic can be determined. Such determinations may also enable tailoring of output of height and lateral audio channels to ensure that corresponding signals can be perceived by the listener at the right time. In other aspects, however, the ceiling characteristic may be determined without determining the distance.

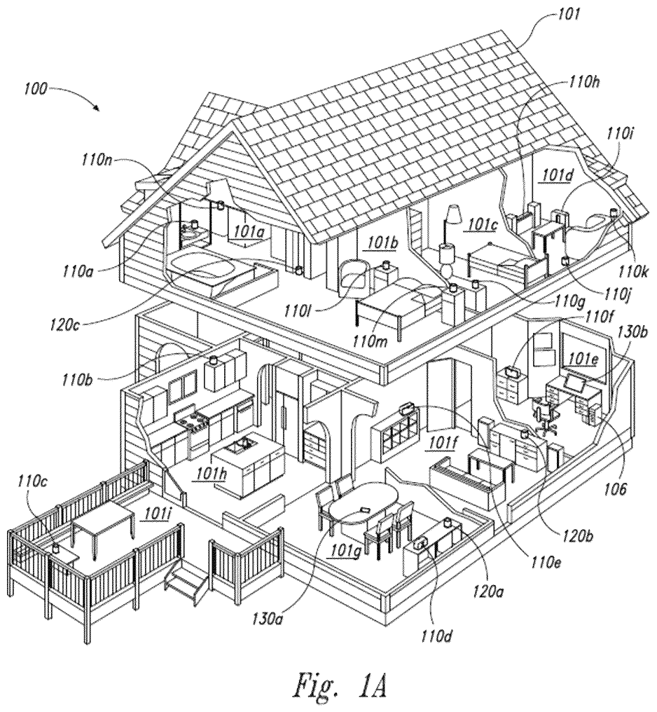

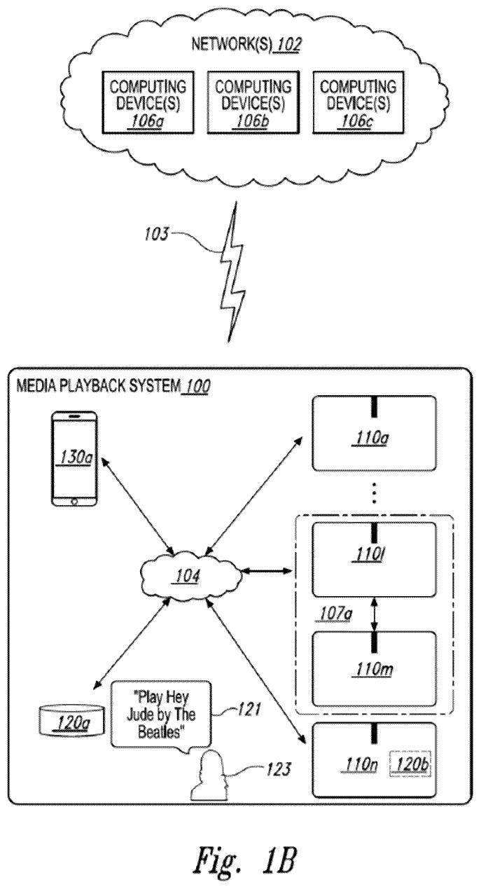

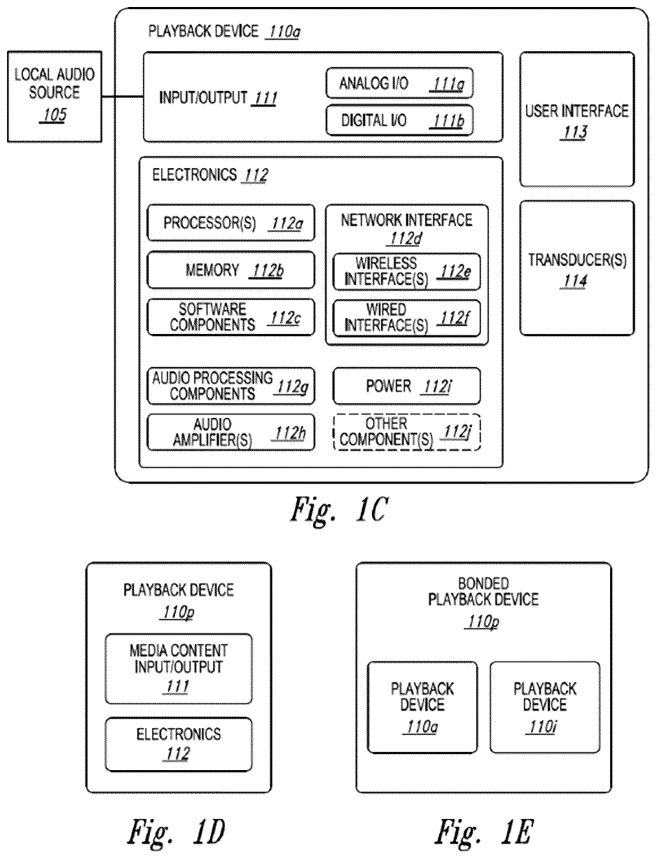

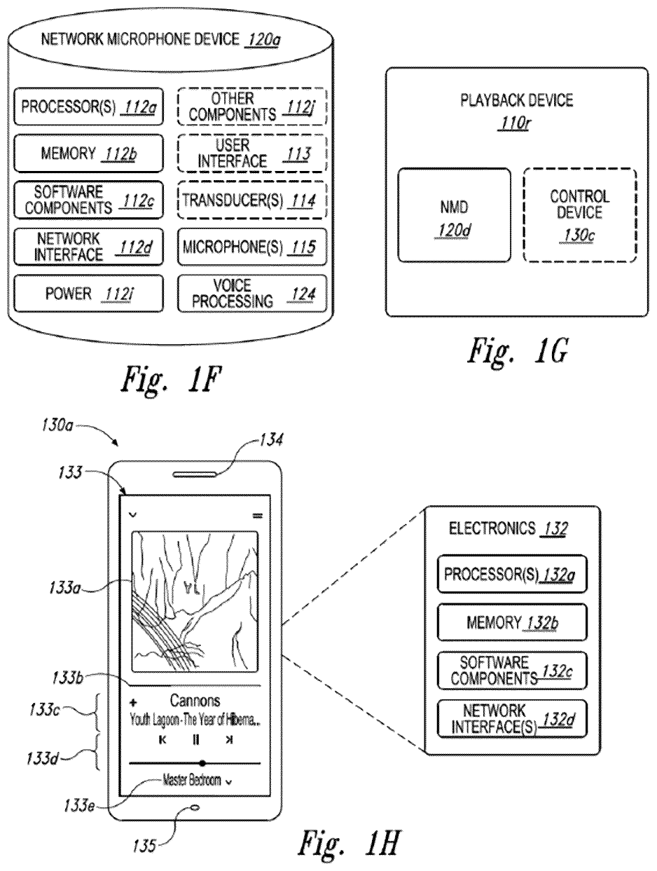

The one or more microphones may be provided in a second playback device, a network microphone device, or a control device. The one or more microphones may be positioned at an expected listener location. The processors and/or the memory may be included in the first playback device, a network microphone device, or a control device. Example playback devices, network microphone devices, and control devices are described below in relation to FIGS. 1A to 4D.

The first upward-firing transducer may be oriented at a vertical or substantially vertical angle, in use. The first upward-firing transducer may be oriented at an oblique angle relative to the first horizontal-firing transducer. The first horizontal-firing transducer may be a forward-firing transducer or a side-firing transducer, examples of which are described below in relation to the Figures.

The first playback device may include more than one horizontal-firing transducer. Each of the more than one horizontal-firing transducers may output one or more second audio signals, and the distance may be determined based on the second audio signals received at the one or more microphones from one of the horizontal-firing transducers or from each of the horizontal-firing transducers. The distance may be an average distance of the first playback device from the one-or-more microphones or a shortest distance between the first playback device and the one-or-more microphones.

In the method of the present aspect, the distance between the first playback device and the one or more microphones is determined based on a second audio signal. In methods according to other aspects, the distance between the first playback device and the one or more microphones may be determined other than by using the second audio signal, and therefore without outputting the second audio signal. The distance may be provided by a user based on a measurement or may be provided from a measurement device. The measurement device may determine the distance using augmented reality or one or more other distance-measuring tools. The distance may be already known and determined from memory; the distance may be pre-stored in memory based on a previous measurement or may be known based on device specifications. In particular examples, the one or more microphones may be provided in the first playback device, such that the distance between the one or more microphones and the upward-firing transducer is fixed.

The first and/or second audio signals may comprise audio at a single frequency or over a plurality of frequencies. For example, an audio signal may comprise a single tone, a plurality of tones, or a sequence of tones. The plurality of tones or sequence of tones may be completely or partially overlapping. Where multiple tones are output as an audio signal, they may form a pleasant musical sequence, such as a chord or a melody. The audio signal may comprise music. The first and/or second audio signal may comprise a sweep signal across a range of frequencies. The first and second audio signals may be the same or may differ.

Reflections of other audio signals from the ceiling may additionally be used to determine the ceiling characteristic. The media playback system may include a second upward-firing transducer. One or more third audio signals may be output from the second upward-firing transducer. A reflection of the one or more third audio signals from the ceiling may be received at the one or more microphones and the ceiling characteristic may be determined based on the reflection of the one or more third audio signals. The third audio signal may be the same as the first and/or the second audio signal or may differ from one or both audio signals. The second upward-firing transducer may be provided in the first playback device, or may be provided in a second playback device in the listening environment that is different to the first playback device. The second upward-firing transducer may be horizontally spaced apart from the first upward-firing transducer. In a particular example, the second upward-firing transducer may be at an opposite end of a soundbar to the first upward-firing transducer. Using reflections form both a first and a second upward-firing transducer in this way may characterize different portions of the ceiling between the transducers and the microphone(s).

Where a second upward-firing transducer is used, a distance between the first and second upward-firing transducers may be known and fixed, such as in a soundbar. The distance between the first and second upward-firing transducers may be determined and used to determine the ceiling characteristic instead of the distance between the playback device and the one or more microphones.

Further direct signals or reflections may also be utilized to aid ceiling characteristic determination. The media playback system may comprise a second horizontal-firing transducer, which may be provided at a second playback device. One or more fourth audio signals may be output from the second horizontal-firing transducer. The fourth audio signals may be received at the one or more microphones and a distance between the second playback device and the one or more microphones may be determined based on the received fourth audio signals. The ceiling characteristic can be determined based on the determined distance between the second playback device and the one or more microphones. Additional signals may enable wider regions of a ceiling to be characterized.

Where a second playback device is provided, a distance may be determined between the first playback device and the second playback device and determining the ceiling characteristic based on the distance between the first playback device and the second playback device. The second playback device may include at least one further microphone, and one or more second audio signals output by the first horizontal-firing transducer may be received at the at least one further microphone. The distance between the first playback device and the second playback device may be determined based on the one or more second audio signals. Alternatively, or additionally, the second playback device may include a second horizontal-firing transducer, and the first playback device may include at least one further microphones, and the method may comprise receiving, at the at least one further microphone, one or more fourth audio signals output by the second horizontal-firing transducer and determining the distance between the first playback device and the second playback device based on the one or more fourth audio signals. The distance may be determined based on measurements other than received audio signals, such as based on a measurement via augmented reality, another measurement means, or other user input, or based on stored data. Distances between playback devices may be determined using ultrasonic audio signals. Examples are discussed in US 2013/0170647 A1, U.S. Pat. No. 10,277,981 B1, and WO 2023/056336 A1, incorporated herein by reference in their entirety.

In some examples, the second playback device may include the one or more microphones and the ceiling characteristic may be determined based on first audio signals reflected off the ceiling between the first playback device and the second playback device and second audio signals output from the first playback device. In other aspects, the one or more microphones may be distributed between the first and second playback devices, and the first playback device may be configured to output the first audio signals to be received by the microphones at the second playback device and the second playback device may be configured to output the second audio signals to be received by the microphones at the first playback device. Generally, determining characteristics of the ceiling based on reflections between a first playback device and microphones and between a first playback device and a second playback device may enable a yet wider region of the ceiling to be characterized. Furthermore, greater detail may be determined relating to the ceiling, such as profiles, differences in particular characteristics, different constructions, absorptions, diffusions, or materials etc.

Third, fourth, and yet further playback devices may be used to further improve ceiling characteristic determination. Playback devices may be positioned on opposite sides or a same side of the one or more microphones. For example, the first and second playback devices may be satellite playback devices of a media playback system positioned behind a listener location at which the one or more microphones are located with respect to, for example, a television or a screen. A third playback device comprising a soundbar beneath the television or screen may be provided in front of the listener location. Thus, the ceiling may be characterized to multiple sides of the listener location, so that height audio channels can be rendered with ease from in front of and behind the listener.

Improvements in the characterization of the ceiling may also be achieved by using multiple microphones spaced apart from one another. Reflections from different parts of the ceiling may be received at different microphones, even where only a single playback device is used. Accordingly, the media playback system may comprise a first network device including a first microphone of the one or more microphones and a second network device including a second microphone of the one or more microphones. The reflection from the ceiling of the one or more first audio signals may be received at the first microphone and a further reflection from the ceiling of the one or more first audio signals may be received at the second microphone. The ceiling characteristic may be determined based on the reflection and the further reflection of the one or more first audio signals.

In addition to reflections from the ceiling between devices, ceiling reflections back to the same playback device may be used in determining ceiling characteristics. A local ceiling distance may be determined based on an audio signal output by a playback device and its reflection received by microphones of the same playback device. To determine a local ceiling distance, the first playback device may comprise at least one further microphone. A further reflection of the one or more first audio signals may be received, at the at least one further microphone of the first playback device and, based on the further reflection from the ceiling of the one or more first audio signals, the local ceiling distance may be determined.

Known or predetermined dimensions may be used to better understand relative heights and locations of the playback devices and microphones. At least one microphone of the one or more microphones may have a predetermined height. For example, it may be provided in a known position of a playback device, and the playback device may be positioned on the floor or on a stand of known height. An example of such a playback device may be a subwoofer, which are conventionally positioned on or close to a floor. The playback device may be configured to determine that it is positioned on the floor or on a stand. Some playback devices may have multiple orientations, and an accelerometer or other measurement means within the playback device may also be configured to determine the orientation of the playback device. A user may provide information relating to heights of the devices and microphones via a user interface. The ceiling characteristic may be determined based on the predetermined height.

The one or more microphones may be provided at a network device. The network device may be a portable playback device. The network device and the first playback device may be time-synchronized. Alternatively, the one or more microphones may be provided at a control device, such as a user's mobile device, tablet, or laptop computer. The network device may be time-synchronized with the first playback device using time-synchronization software. Time synchronization may be particularly useful in ensuring precise and accurate determination of times of arrival of different reflections and audio signals, which in turn may enable precise characterization of the ceiling. Details regarding synchronization among playback devices can be found, for example, in U.S. Pat. No. 8,234,395 entitled, “System and method for synchronizing operations among a plurality of independently clocked digital data processing devices,” which is incorporated herein by reference in its entirety.

The above technique, alone or in combination, may enable various different ceiling characteristics to be determined. The ceiling characteristic may comprise at least one of: a distance; a shape; an absorption; a diffusion; a material; or a frequency response.

The distance may comprise an average ceiling distance. An average ceiling distance may be the average height of a ceiling portion between the first playback device and the one or more microphones. The average height may vary depending on variations in ceiling profile. The distance may comprise a maximum or minimum ceiling height between the playback device and the one or more microphones.

A shape may comprise a profile or a plurality of different heights relative to the first playback device and one or more microphones. The shape may be categorized according to a plurality of predetermined categories, such as flat, slanted, pitched, barrel, coffered or multi-level, or coved. A shape of the ceiling may be determined based on more than one reflection. Some examples may use a plane array of transducers, such as a plane array of upwardly-firing transducers, to generate audio at different angles using beam-forming techniques, such as beams differing by 5°, 10° or 20° in direction from each other. This may allow more detail of the ceiling shape to be determined.

An absorption, diffusion, or material/construction of a ceiling may be determined based on an intensity of the reflections from the ceiling compared to an output intensity from the transducer and/or based on reverberations or other room effects. A material may be determined based on an absorption or diffusion. In some examples, absorption and diffusion may result in much the same effect (e.g. an attenuated sound at the one or more microphones). Diffusion and absorption may be disambiguated in various ways. For example, an RT60 measurement may indicate diffusion if it is longer. RT60 measures the time for a sound pressure level in a room to decrease by 60 dB after the sound source has stopped. It may be measured by emitting an audio signal which is an impulse and measuring its decay with an omnidirectional microphone. The time for the sound pressure level recorded to decrease by 60 dB may then be determined from the recording. Alternatively, or additionally, diffusion may be identified by using a highly directional sound source and determining whether a specular reflection can be detected, which may involve moving the one or more microphones to different positions.

A frequency response may also be determined, for example any reflection from a ceiling may be dependent on frequency. Frequency response may represent other qualities such as absorption and/or diffusion in terms of their results on the sound, which may be useful in determining any adjustments required.

The ceiling characteristic may indicate that there is no ceiling or that the ceiling or listening environment in general is partially open, i.e. the playback devices are positioned outside or in an environment without a ceiling or that is only partially covered, such as a patio, a garden, a terrace, a porch, etc. Such a determination may be made if no reflection off the ceiling is received at the one or more microphones. A lack of reflection may also indicate a highly diffuse ceiling, so that reflections are attenuated perhaps to a level where they are difficult to distinguish from noise. An RT60 measurement, as discussed above, may help to distinguish between a diffuse ceiling and a partially open or no ceiling. For example, an environment with a diffuse ceiling may have a longer RT60 measurement than an environment with a partially open or no ceiling.

In some examples the ceiling characteristic may be indicative of overall room volume and/or dimensions. For example, RT60 measurements may be useful in this case.

Based on a determined ceiling characteristic, an audio output parameter for the first playback device, and/or the media playback system more generally, may be adjusted. The audio output parameter may comprise a delay parameter for height audio channels and/or lateral audio channels or for one or more transducers. For example, a delay may be implemented to output one of the lateral or height audio channels later than the other so that they may be perceived by a listener in the so-called sweet spot at the same time. The audio output parameter may comprise an amplitude or volume output level for the first upward-firing transducer or for height audio channels. Determining that the ceiling has particularly absorptive qualities may be counteracted with an increase in a volume for height audio channels, so that height audio and lateral audio arriving at and being perceived by a listener is substantially balanced. The audio output parameter may comprise a frequency cutoff. If it is determined that no ceiling is present, height audio channels may not be output from upward-firing transducers, and instead may be output from horizontal-facing transducers. Adjusting the audio output parameter may comprise adjusting a distribution of audio content between different transducers of the first playback device or between different devices, as will be described in more detail below.

According to a further aspect, there is provided a method comprising: outputting, via a first transducer in a first playback device in a listening environment, a first signal, wherein the first transducer is an upward-firing transducer; outputting, via a second transducer in a second playback device in the listening environment, a second signal; receiving, via one or more microphones in a network device in the listening environment, (i) a reflection of the first signal and (ii) the second signal; determining, via the received reflection of the first signal, a ceiling characteristic of the listening environment; determining, via the received second signal, a first distance between the second playback device and the network device; and adjusting a distribution of audio output between the first transducer and the second transducer based on (i) the ceiling characteristic and (ii) the first distance.

The method may be implemented by a media playback system. The media playback system comprises the first playback device including the first transducer, the second playback device including the second transducer, and the network device including the one or more microphones. The media playback system further includes one or more processors and memory storing instructions for execution by the one or more processors. The instructions, when executed by the one or more processors, cause the media playback system to perform the steps of the method.

Adjusting a distribution of audio output between two transducers dependent on ceiling characteristics and distances of a transducer from a listener position may be useful in many different circumstances to improve a listener experience of immersive audio. The techniques described herein may be particularly useful for height audio reproduction. As will be expanded upon below, these techniques may be useful where the first playback device is at an undesirable location or where different types of audio content are provided to a media playback system comprising the two playback devices. Other uses may include when the second playback device is a new playback device that is added to a media playback system for synchronous audio playback with the first playback device, and/or where the first and second playback devices are different types of playback devices (such as soundbars, satellite devices, or subwoofers).

When positioning the first playback device, a user may desire to position the first playback device in a bookshelf, in a cubby or other portion of a room with a restricted height, or in another position at which reproducing height audio may be difficult because of a height restriction. Reproducing height audio channels via an upward-firing transducer where a first playback device is positioned in a limited-height location of the room may result in a suboptimal listening experience. The ceiling characteristic may be used to determine this; based on the ceiling characteristic, it may be determined that the first transducer is at an unsuitable position within the listening environment. It may be determined that the first transducer is at the unsuitable position within the listening environment by at least one of: determining that the first transducer is directed towards a boundary of the listening environment other than the ceiling of the listening environment; or determining that the first transducer is less than a predetermined distance from at least a portion of the ceiling. These characteristics may be determined based on reflections from the boundary or ceiling being received at the first playback device more quickly than would otherwise be expected, by reflections not being received at the microphones of the network device, or by receiving unusual reflections at the network device.

The distribution of audio output may be adjusted by adjusting a first audio output parameter of the first transducer or adjusting a second audio output parameter of the second transducer based on determining that first transducer is at the unsuitable position. The distribution of audio output may be adjusted by at least one of: disabling the first transducer; reducing an audio output volume of the first transducer; or adjusting a directivity of the audio output from the first transducer. The distribution of audio output may be adjusted by at least one of: outputting at least a portion of audio content intended for the first transducer via the second transducer; increasing an audio output volume of the second transducer; or outputting an audio signal for cancelling at least part of the audio output of the first transducer. Two or more of these adjustments may be combined to improve the listening experience of a listener.

For unsuitably located playback devices or in other situations where redistribution of the audio content may be desirable, such as due to a particular ceiling characteristic making height audio reproduction by reflection difficult, vertical audio content may be redistributed. In some embodiments, the second transducer may be a horizontal-firing transducer. Audio output data may be received that comprises vertical audio content and horizontal audio content, and the distribution of audio output may be adjusted by outputting, from the second transducer, the horizontal audio content and at least a portion of the vertical audio content.

Some media playback systems may comprise speakers in front of a listener location but not behind. Some audio content may be for reproduction from behind the listener location. In response to receiving audio output data comprising first audio content and second audio content, wherein the first audio content is for reproduction from a perceived position in front of a listener and the second audio content is for reproduction from a perceived position behind the listener, the distribution of audio output may be adjusted by: outputting, from a second transducer comprising a horizontal-firing transducer positioned in front of the listener, at least a portion of the first audio content; and outputting, from the first transducer, at least a portion of the second audio content based on the ceiling characteristic. As a result, the second audio content can be perceived by the listener as height audio to at least partially distinguish it from the first audio content. Depending on the ceiling and other listening environment characteristics, the second audio content may be reproduced so that it reflects from the ceiling to be perceived by the listener as originating from behind their listening location. In alternative examples, playback devices may be positioned behind the listener, and in these examples the first audio content may be reproduced by the first transducer and the second audio content may be reproduced by the second transducer. The distribution of audio output may be adjusted by outputting, from the first transducer, an audio signal for cancelling at least part of the first audio content in the direction of the ceiling of the listening environment. Cancelling may be most effective when the first transducer and second transducer are positioned along the dimension of the ceiling and floor, for example. one nearer the floor, and another spaced apart, such as opposite, and nearer the ceiling. Such embodiments may also be applied in other aspects where both the first and second transducer are provided in the same playback device.

Unwanted effects in listening environments may be counteracted using targeted height audio. The distribution of audio output may be adjusted by outputting, from the first transducer, at least one audio signal to counteract a listening environment mode with the ceiling when the second transducer is operational. Additionally or alternatively, the distribution of audio output may be adjusted by adjusting the output of the second transducer to attenuate one or more frequencies to counteract a listening environment mode with the ceiling. The second transducer may have an output including frequencies below 200 Hz.

Particular arrangements of media playback systems may be optimized. It may be determined that, based on the ceiling characteristic, a first path between the first transducer and a typical listener position via the ceiling is shorter than a second path between the second transducer, which may be an upward-firing transducer, and the typical listener position via the ceiling. The distribution of audio output may be adjusted between the first transducer and the second transducer. In one example, audio output may be adjusted such that audio output from the first transducer includes higher frequencies than the audio output from the second transducer. As a result, high frequency height audio is output along a more direct path towards the listener than lower frequencies, resulting in a better listening experience. Accordingly, it may be more useful to ensure that the higher frequencies take a more direct path so that they are more likely to be perceived by the user. Audio at higher frequencies may contain specific information such as speech or other details, whereas lower frequencies may be used more for generating a field or background. Moreover, high frequency audio may attenuate more than low frequency audio, so it is useful to transmit it to the listener along a more direct and shorter path to reduce such attenuation. “High frequency” in this context may be audio above about 250 Hz. above about 1 kHz, above about 2 kHz or above about 3 kHz. Other changes in distribution of audio output between the first and second transducers are also possible. For example additionally, or alternatively, higher frequencies may be amplified or “boosted” on the first transducer to “balance” the perceived height from the first and second transducers. Another example, that may be applied additionally or alternatively, is to apply a delay to the first transducer path, so as to substantially equalize the time that sound via the ceiling from the first transducer and the second transducer reaches the listener at substantially the same time.

According to a further aspect, there is provided one or more tangible, non-transitory computer-readable media storing instructions that, when executed by one or more processors of a media playback system, cause the media playback system to perform any of the methods as described herein.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular examples of the disclosed technology. Accordingly, other examples can have other details, dimensions, angles and features without departing from the spirit or scope of the disclosure. In addition, those of ordinary skill in the art will appreciate that further examples of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples and examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable. Each room, space, or playback zone other than the patio 101i is bounded by a ceiling. Ceiling characteristics may differ between rooms, spaces, or playback zones.

The media playback system 100 can comprise one or more playback zones, some of which may correspond to the rooms in the environment 101. Each of the playback zones and/or the individual rooms may be referred to as a listening environment. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated by reference above.

### A. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 may be configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for instance, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the playback devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 of FIG. 1B includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media playback system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110. Although the media playback system 100 is shown as including a plurality of playback devices 110a-110n, an NMD 120a, a control device 130a, and a network 104, in other examples the media playback system 100 may include one playback device incorporating an upward-firing transducer and one or more microphones, as well as a processor and memory stored at, for example, the playback device, a network microphone device, or a control device.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). At least one of the transducers is an upward-firing transducer. The one or more transducers may include further upward-firing transducers and/or a horizontal-firing transducer. The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some examples, the playback device 110a optionally includes one or more microphones 115 (e.g., a single microphone, a plurality of microphones, a microphone array) (hereinafter referred to as “the microphones 115”). In certain examples, for instance, the playback device 110a having one or more of the optional microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “MOVE,” “PLAY:5,” “BEAM,” “PLAYBAR,” “PLAYBASE,” “PORT,” “BOOST,” “AMP,” and “SUB.” Other suitable playback devices may additionally or alternatively be used to implement the playback devices of example examples disclosed herein. Additionally, one of ordinary skilled in the art will appreciate that a playback device is not limited to the examples described herein or to SONOS product offerings. In some examples, for instance, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

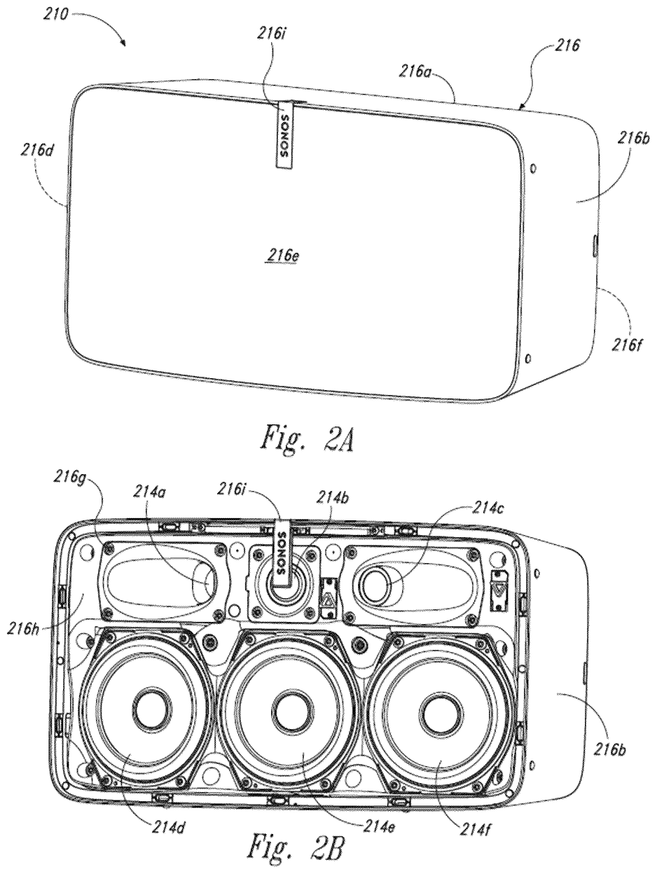

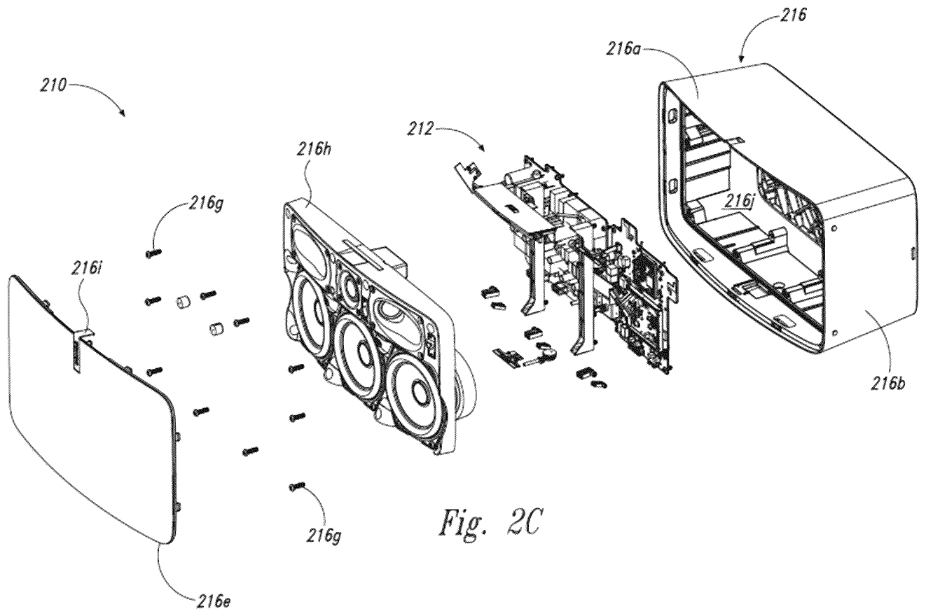

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some examples, for instance, the playback device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device. Additional playback device examples are described in further detail below with respect to FIG. 2A-2C.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some examples, the NMD 120a is configured as a media playback device (e.g., one or more of the playback devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™, an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™, an Android phone). In some examples, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Example Playback Devices

FIG. 2A is a front isometric view of a playback device 210 configured in accordance with examples of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some examples, the playback device 210 includes a number of transducers different than those illustrated in FIGS. 2A-2C. For example, the playback device 210 can include fewer than six transducers (e.g., one, two, three). In other examples, however, the playback device 210 includes more than six transducers (e.g., nine, ten). Moreover, in some examples, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated example of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some examples, however, the playback device 210 omits the filter 216i. In other examples, the playback device 210 includes one or more additional filters aligned with the transducers 214b and/or at least another of the transducers 214.

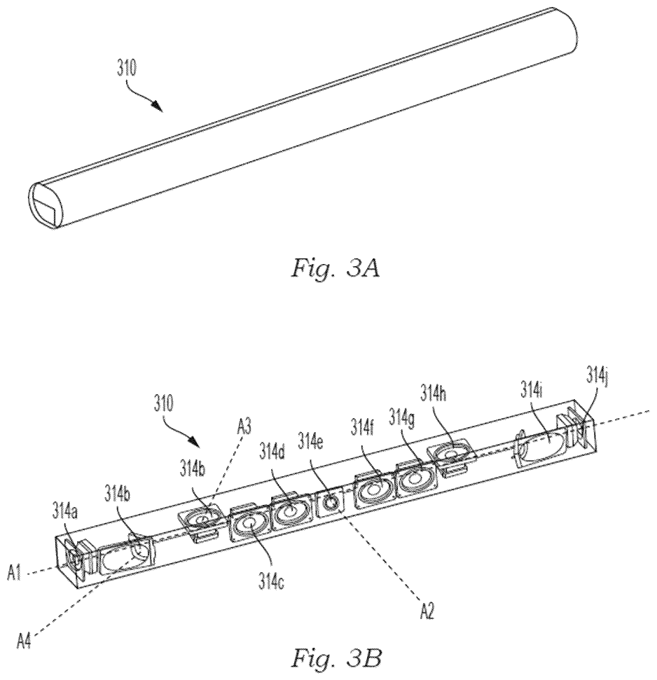

FIG. 3A is a perspective view of a playback device 310, and FIG. 3B shows the device 310 with the outer body drawn transparently to illustrate the plurality of transducers 314a-j therein (collectively “transducers 314”). The transducers 314 can be similar or identical to any one of the transducers 214a-f described previously. In this example, the playback device 310 takes the form of a soundbar that is elongated along a horizontal axis A1 and is configured to face along a primary sound axis A2 that is substantially orthogonal to the first horizontal axis A1. In other examples, the playback device 310 can assume other forms, for example having more or fewer transducers, having other form-factors, or having any other suitable modifications with respect to the example shown in FIGS. 3A and 3B. In various implementations, the playback device 310 can serve as a home theatre primary playback device, and may be placed in a center front position of a home theatre listening environment. In such a configuration, the playback device 310 can play back home theatre audio synchronously with playback via one or more satellite playback devices, which can be arranged about the listening environment in a suitable configuration. Additional details regarding home theatre audio playback can be found, for example, in U.S. Patent Application No. 63/377,897 entitled, “Home Theatre Audio Playback With Multichannel Satellite Playback Devices,” which is incorporated herein by reference in its entirety.

The playback device 310 can include individual transducers 314a-j oriented in different directions or otherwise configured to direct sound along different sound axes. For example, the transducers 314c-g can be configured to direct sound primarily along directions parallel to the primary sound axis A2 of the playback device 310, and may be referred to as horizontal, forward-firing transducers. Additionally, the playback device 310 can include left and right upward-firing transducers (e.g., transducers 314b and 314h) that are configured to direct sound along axes that are angled vertically with respect to the primary sound axis A2. For example, the left upward-firing transducer 314b is configured to direct sound along the axis A3, which is vertically angled with respect to the horizontal primary axis A2. In some examples, the upward-firing sound axis A3 can be angled with respect to the primary sound axis A2 by between about 50 degrees and about 90 degrees, between about 60 degrees and about 80 degrees, or about 70 degrees.

The playback device 310 can optionally include one or more horizontal, side-firing transducers (e.g., transducers 314a, 314b, 314i, and 314j), which can direct sound along axes that are horizontally angled with respect to the primary sound axis A2. In the illustrated example, the outermost transducers 314a and 314j can be configured to direct sound primarily along the first horizontal axis A1 or at least partially horizontally angled therefrom, while the side-firing transducers 314b and 314i are configured to direct sound along an axis that lies between the axes A1 and A2. For example, the left side-firing transducer 314b is configured to direct sound along axis A4.

In playback devices that do not have such side-firing transducers, side-propagating audio can be achieved by use of arrays, in which the audio output by each transducer sums in manner that the combined output has a directivity and is oriented along a side-propagating axis.

In operation, the playback device 310 can be utilized to play back 3D audio content that includes a vertical component (also referred to herein as a “height component”). As noted previously, certain 3D audio or other immersive audio formats include one or more height channels in addition to any lateral (e.g., left, right, front) channels. Examples of such 3D audio formats include DOLBY ATMOS, MPEG-H, and DTS:X formats. In playback devices that do not have such upward-firing transducers, upward-propagating audio can be achieved by use of arrays, in which the audio output by each transducer sums in a manner that the combined output has a directivity and is oriented along a vertically propagating axis.

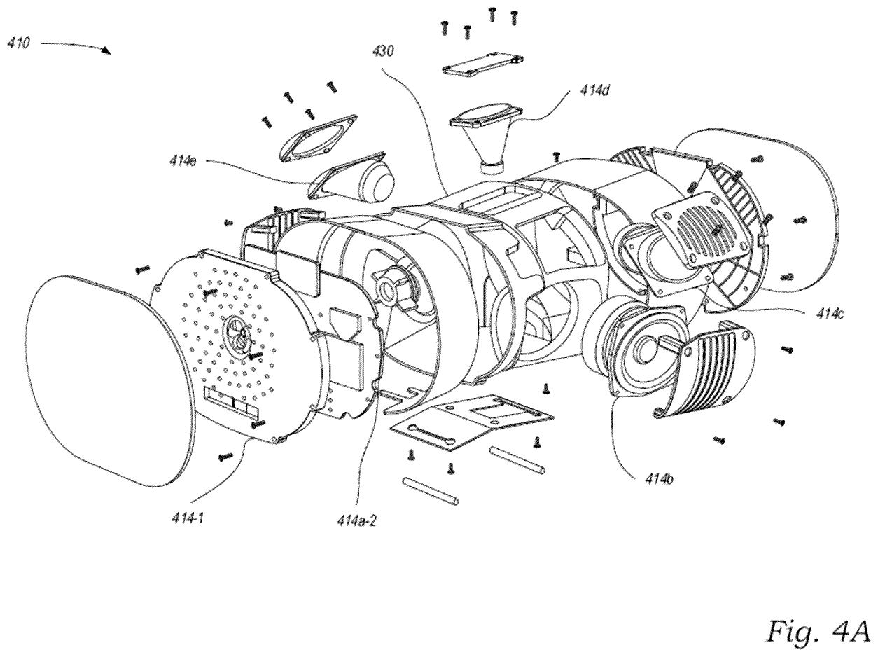

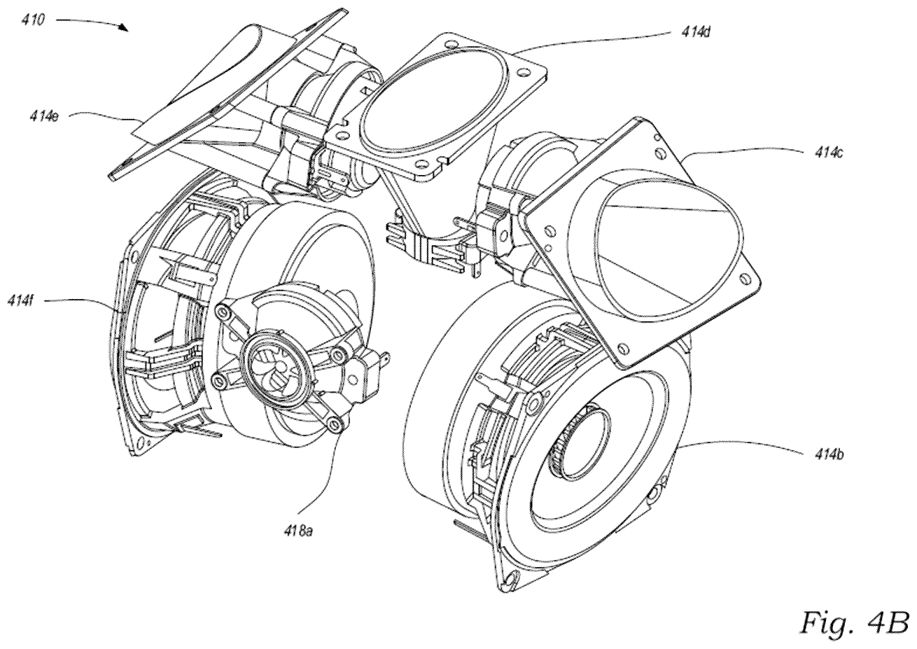

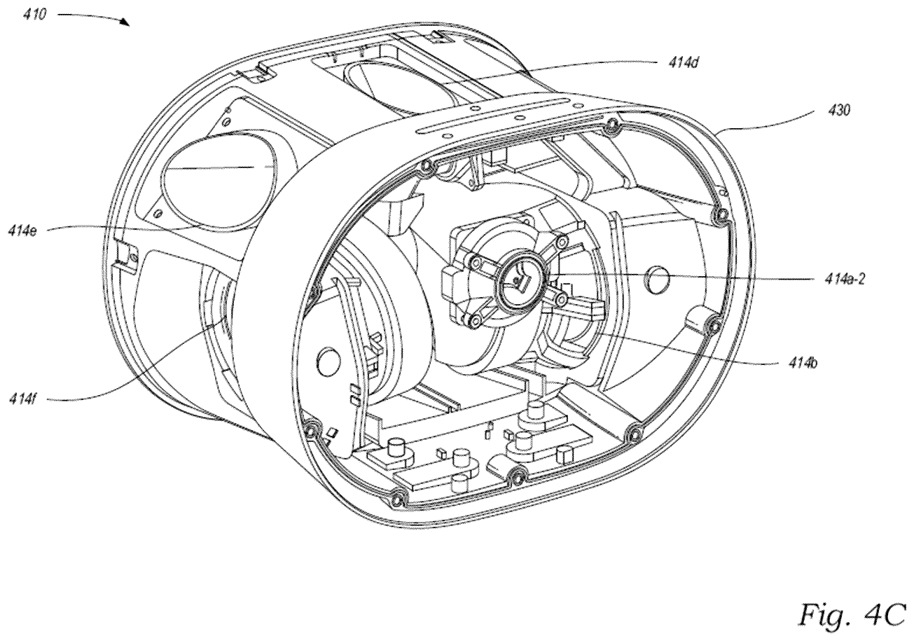

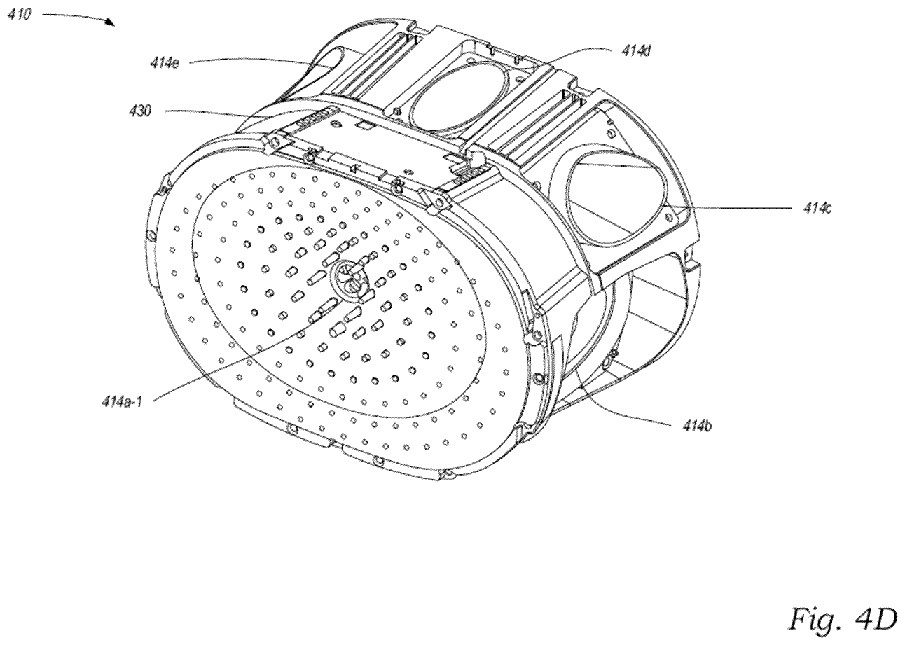

In example implementations, various techniques described herein may be carried out with a playback device that includes multiple audio transducers, and may optionally be used as a multichannel satellite playback device for home theatre applications. By way of illustration, FIG. 4A is an exploded view of a playback device 410 that includes a plurality of speakers 414. In particular, the speakers 414 include a forward firing transducer 414a, a side-firing transducer 414b, a side-firing transducer 414c, an upward-firing transducer 414d, a side-firing transducer 414e, and a side-firing transducer 414f (not shown). The speakers 414 are carried in a housing 430. The playback device 410 may otherwise include components the same as or similar to the playback devices 110a (FIGS. 1C), 210 (FIG. 2A) or 310 (FIG. 3A), which may be carried by the housing 430.

As shown in the exploded view of FIG. 4A, the forward-firing transducer 414a is comprised of several components, including a first component 414a-1 and a second component 414a-b. In assembly, the first component 414a-1 and the second component 414a-b are joined to form the forward-firing transducer 414a. In other examples, the side-firing transducer 414a may be formed from a single component. Within example implementations, the other speakers 414 as well as the other components may be formed from one or more multiple components as well.

Within examples, the speakers may have a particular arrangement relative to one another. FIG. 4B is a partial view of the playback device 410 which illustrates the speakers 414 in an example arrangement. As shown, the forward firing transducer 414a is oriented in a first direction (i.e., forward). The side-firing transducer 414b and the side-firing transducer 414f are implemented as respective woofers and are oriented in second and third directions that are approximately 180° from one another and approximately 90° from the first direction in the horizontal plane.

In this example, three of the speakers 414 are implemented as tweeters. These include the side-firing transducer 414c and the side-firing transducer 414e, which are similarly oriented as the side-firing transducer 414b and the side-firing transducer 414b. The tweeters also include the upward-firing transducer 414d, which is oriented in a fourth direction approximately 70° from the first direction in the vertical plane. As shown, the side-firing transducer 414c, the side-firing transducer 414e, the upward-firing transducer 414d also include respective horns.

The arrangements of the speakers 414 may have particular acoustic effects. For instance, the arrangement of the side-firing transducer 414c and the side-firing transducer 414e may provide an ambient effect when surround content is output via the side-firing transducer 414c and the side-firing transducer 414e respectively. The similar arrangement of the side-firing transducers 414b and the side-firing transducer 414f may have a similar effect. In contrast, the forward-firing transducer 414a has a relatively more direct sound (assuming that the playback device 410 is oriented such that the primary direction of output 414a is more oriented toward the user(s) relative to the primary direction of output of the side-firing transducers 414).

To provide further illustration, FIG. 4C is a view showing the playback device 410 as partially assembled. FIG. 4C shows the housing 430 carrying the side-firing transducer 414b, the upward-firing transducer 414d, the side-firing transducer 414e, and the side-firing transducer 414e, as well as the second component 414a-2 of the forward-firing transducer 414a. The first component 414a-1 is not shown in FIG. 4C in order to provide a partial interior view of the housing 430.

FIG. 4D is a further view showing the playback device 410 also as partially assembled (without the exterior speaker grilles and trim). FIG. 4D shows the housing 430 carrying the side-firing transducer 414b, the side-firing transducer 414c, the upward-firing transducer 414d, and the side-firing transducer 414e. In this view, the first component 414a-1 of the forward-firing transducer 414a is connected to the second component 414a-2.

### IV. Example Techniques for Ceiling Characteristic Determination and Audio Output Adjustment

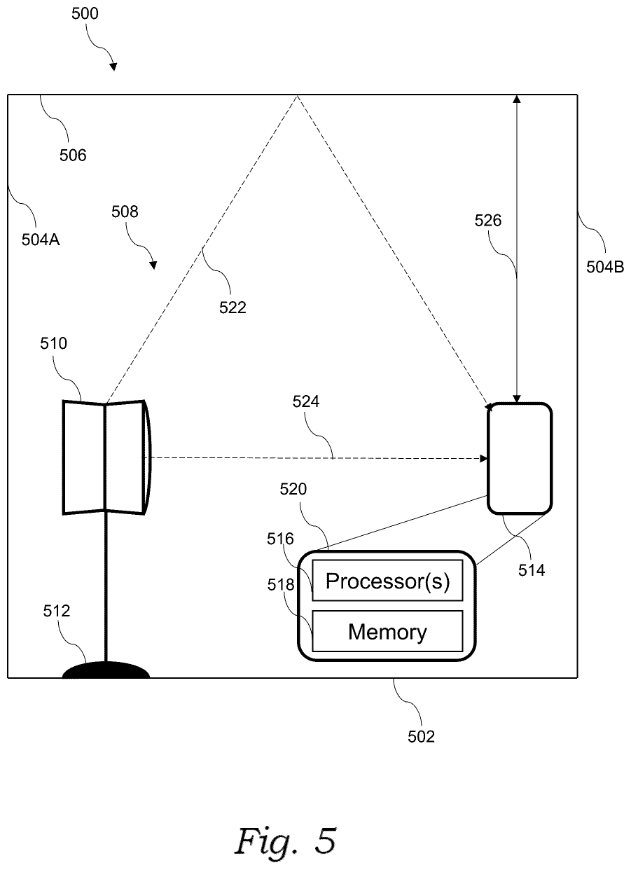

FIG. 5 is a side schematic diagram of how a media playback system may be configured to determine a ceiling characteristic. In FIG. 5, a listening environment 500 is illustrated, defined by a floor 502, a left wall 504A and a right wall 504B, and a ceiling 506. Although not visible, the listening environment may be defined by other walls or boundaries. The listening environment 500 may be substantially enclosed. In the example of FIG. 5, the floor 502, walls 504A, 504B and ceiling 506 are flat for clarity of explanation. However, the present disclosure can be applied to floors, ceilings, and walls may take any form and have any construction or material. The listening environment may be or comprise a room, space, or playback zone, such as those described in relation to FIG. 1A.

A media playback system 508 is also depicted in FIG. 5. The media playback system 508 includes a first playback device 510, positioned in the listening environment 500. The first playback device 510 is mounted on a stand 512 on the floor 502, and is positioned within the listening environment 500 so that it is facing the right wall 504A. At least one upward-firing transducer and at least one horizontal-facing transducer are provided in the first playback device 510, although these are not visible in FIG. 5. The first playback device 510 is oriented such that the upward-firing transducer is oriented at a substantially vertical angle towards the ceiling 506, while the horizontal-firing transducer is oriented towards the right wall 504B. The first playback device 510 is depicted as being an example of the playback device 410 as described in relation to FIGS. 4A to 4D above, although the first playback device 510 may also be a playback device 310 as described above in FIGS. 3A and 3B or another playback device incorporating at least one upward-firing transducer and at least one horizontal-facing transducer.

The media playback system 508 also includes a control device 514 operated by a user. The control device may have some or all of the features of the control device 130a as described in relation to FIGS. 1A, 1B, and 1H. The control device 514 includes one or more microphones, although these are not shown in FIG. 5 for clarity. The control device 514 is located at a listener location and so is spaced apart, horizontally, from the playback device 510. A user may position or hold the control device 514 at the listener location. The listener location may be a location at which the listener, or more specifically the listener's head, is expected to be during audio playback, and so may be a position on or just above a seat or sofa or another area at which the listener may rest or reside. In other examples, the one or more microphones may be provided at a network microphone device, such as the network microphone device(s) 120a, 120b described in relation to FIGS. 1A, 1B, 1F, and 1G above. The one or more microphones may comprise a standalone microphone or microphones.

The control device 514 includes one or more processors 516 and memory 518, shown together in box 520. Although shown as part of the control device 514 in FIG. 5, in other examples, the processor 516 and memory 518 may form part of a different device of the media playback system 508, such as the first playback device 510, a further playback device, a controller, or a remote computing device.

The memory 518 may store instructions representing a method for determining a ceiling characteristic. The instructions, when executed by the processor 516, may cause the media playback system 508 to perform the method. During the method, the first playback device 510 is operated to output audio signals from its transducers. At least one upward, substantially vertical audio signal 522 is output towards the ceiling 506, while at least one horizontal audio signal 524 is output towards the right wall 504B. In FIG. 5, audio signals are indicated using dashed arrows.

The vertical audio signal 522, output by the upward-firing transducer, reflects off the ceiling 506 and the reflection is received at a microphone of the control device 514. The microphone of the control device 514 receives the horizontal audio signal 524 directly from the first playback device 510. The horizontal audio signal 524 may be used to determine a distance between the first playback device 510 and the control device 514. For example, a time of flight may be determined for the horizontal audio signal 524 and a distance may be determined based on the time of flight. If multiple signals corresponding to the horizontal audio signal 524 are received at the microphone, the earliest signal may be used as this corresponds to the shortest distance between the devices.

Based on the reflection of the vertical audio signal 522 and the distance determined between the two devices, one or more ceiling characteristics may be determined. In the instance in FIG. 5, an average height of the ceiling between the first playback device 510 and the control device 514 may be determined. The average height, in this example, is the same height as the height of the first playback device 510 and the control device 514 from the ceiling 506, as indicated by arrow 526. The ceiling characteristic may be a profile of the ceiling, such as indicating that the ceiling 506 is flat. In some examples, it may be determined that the ceiling is flat if a plurality of reflections or measurements based on vertical audio signals indicate that a similar average height of the ceiling 506. The ceiling characteristic may provide information relating to absorption or diffusion characteristics of the ceiling 506, based on differing intensities of the output and received signals. The ceiling characteristic may be determined based on a time-of-flight of the reflection.

The control device 514 and first playback device 510 may be time-synchronized or share a synchronized clock system. Timing synchronization may enable a more accurate determination of time-of-flight measurements because a time reference is shared between the receiver and transmitter, meaning that the distance and ceiling characteristic may be determined more accurately.

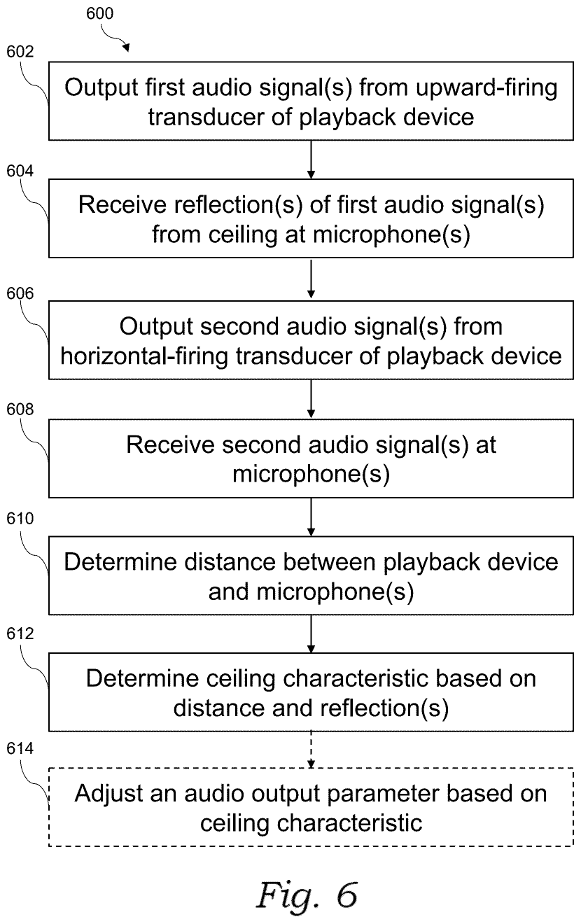

The control device 514 may be portable and may be moved to different positions within the listening environment 500 to enable greater regions of the ceiling 506 to be characterized. The method described above and in relation to FIG. 6 below may be repeated for a plurality of different positions of the control device 514 and a plurality of ceiling characteristics and/or at least one overall ceiling characteristic may be determined.

In some examples, the one or more microphones may be provided at a portable playback device or network microphone device rather than the control device 514. A portable playback device or network microphone device may include microphones that are known and/or more accurately calibrated, resulting in greater reliability in analysis of received signals. In addition, portable playback devices or network microphone devices may form part of a time-synchronized network that enables audio playback, which may result in more precise time synchrony than would be available with control or other devices.

FIG. 6 is a flow chart summarizing the method performed in FIG. 5. The method 600 of FIG. 6 includes, at a first step 602, outputting, from a first upward-firing transducer at a first playback device, i.e. playback device 510, one or more first audio signals. At step 604, the method 600 comprises receiving, at one or more microphones that are horizontally spaced apart from the first upward-firing transducer, a reflection of the one or more first audio signal from a ceiling of a listening environment in which the first playback device and the one or more microphones are positioned. The one or more microphones are provided in the control device 512 in FIG. 5.

At step 606, the method 600 comprises outputting, from a first horizontal-firing transducer at the first playback device, one or more second audio signals. At step 608, at least one second audio signal is received at the one or more microphones. Based on the received second audio signal, at step 610, the method comprises determining a distance between the first playback device and the one or more microphones based on the at least one second audio signal.

At step 612, a ceiling characteristic is determined based on the reflection of the one or more first audio signals and the distance between the first playback device and the one or more microphones. Optionally, at step 614, an audio output parameter may be determined based on the determined ceiling characteristic.

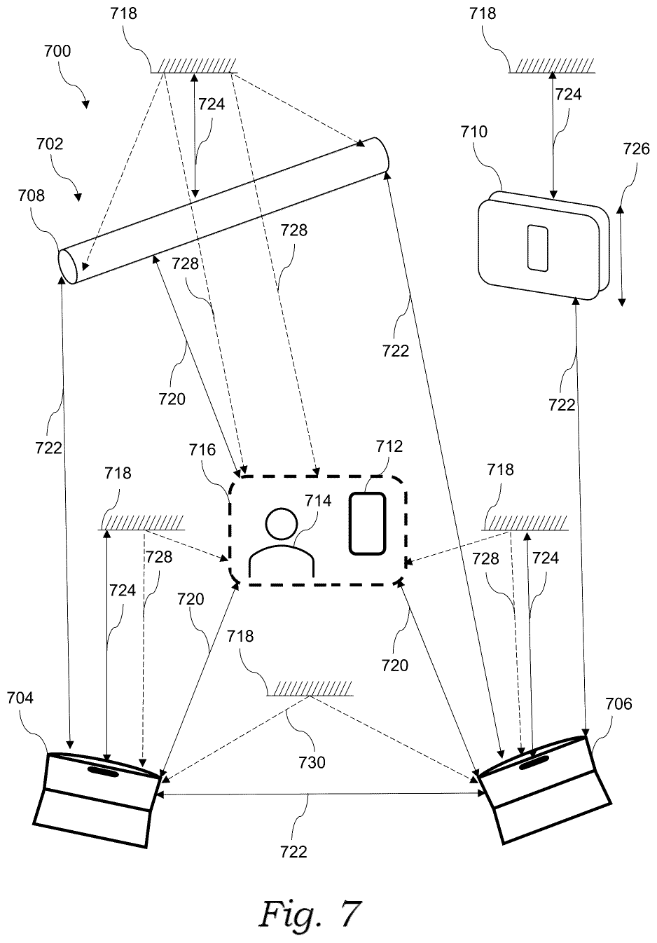

A media playback system may include more than one playback device, as indicated above in relation to FIGS. 1A and 1B. FIG. 7 shows an example listening environment 700 in which a media playback system 702 is provided. FIG. 7 illustrates measurements that may be made by the media playback system 702 to enable ceiling characteristic determination. The media playback system 702 may be configured for home theatre audio playback. Example configurations regarding home theatre audio playback are found, for example, in U.S. Patent Application No. 63/377,897 which is incorporated by reference above.

The media playback system 702 includes four playback devices: a first playback device 704, a second playback device 706, a third playback device 708, and a fourth playback device 710. The playback devices 704, 706, 708, 710 may each include at least one upward-firing transducer and at least one horizontal-firing transducer, and may also include one or more microphones. The first and second playback devices 704, 706 may be examples of playback device 410 in FIGS. 4A to 4D. The third playback device 708 is a soundbar, and may be an example of the device 310 of FIGS. 3A and 3B. The fourth playback device 710 is a subwoofer. The subwoofer may include an upward-firing transducer, which may be a tweeter, as well as one or more microphones, as will now be described.

The media playback system 702 also includes a control device 712 operated by a user 714. The user 714 and the control device 712 are positioned at a listener location 716. The control device 712 includes one or more microphones (not shown).

The listening environment 700 includes a ceiling 718, portions of which are schematically represented in FIG. 7. The media playback system 702 may be configured to determine a ceiling characteristic in accordance with the method 600 of FIG. 6, using one or more of the playback devices 704, 706, 708, 710 and/or the control device 712.

For example, the first playback device 704 may be configured to, as in steps 602 and 606, output first and second audio signals. The first and second audio signals may be received by the control device 712, and a distance and ceiling characteristic may subsequently be determined as in steps 610 and 612. The ceiling characteristic may relate to the whole ceiling or a portion of the ceiling between the first playback device 704 and the control device 712. The first and second audio signals may be received by one or more of the other playback device 706, 708, 710, and the distances between the first playback device and the other playback device 704, 706, 708 and a ceiling characteristic may be determined.

In order to enable characterization of the ceiling, reflections of the ceiling between multiple different devices may be utilized, as may other distances between devices, local ceiling heights, or other measurements. FIG. 7 shows some of the different values that may be determined from the media playback system 702.

As shown in FIG. 7, the playback devices 704, 706, 708 may determine a distance between them and the control device 712. Determining this distance enables a distance from the listener location to be determined. The playback device 710 may also determine this distance, although this is not shown in FIG. 7 for clarity. These distances are labelled in FIG. 7 as distances 720. This distance 720 may be determined by outputting, from each playback device, an audio signal, which is received at one or more microphones of the control device 712.

Distances between the playback devices 704, 706, 708, 710 may be determined. In FIG. 7, the distance between pairs of playback devices 704 and 706, 706 and 710, 706 and 708, and 704 and 708 are shown, and labelled as distances 722. These distances 722 may be determined by either playback device in a pair outputting an audio signal, and the other playback device in the pair receiving the audio signal. The output signal may be the same or a different signal to the signal that is used to determine a distance between the playback device outputting the signal and the control device 712.

Each playback device 704, 706, 708, 710 may be configured to determine a local ceiling distance 724. A local ceiling distance 724 may be determined by a playback device outputting a signal, receiving, at one or more microphones of that same playback device, a reflection of the signal from the ceiling 718 directly above the playback device, and determining the local ceiling distance 724 based on the reflection. A local ceiling distance 724 may be a measure of the distance of the playback device to the ceiling, rather than of the overall height of the ceiling 718. However, a total ceiling height, at least locally, may be determined if a height of the microphone receiving the reflection and/or the transducer outputting the signal is known. An example of a known microphone and transducer height is in the fourth playback device 710. The fourth playback device 710, being a subwoofer, may be located on a floor of the listening environment 700. The height 726 of the microphone and transducer may be known in the playback device 710, meaning that a combination of the determined local ceiling height above the device 710 and the known, or predetermined, height 726 of the microphones can give the overall local ceiling height.

During a setup process, a user may be directed to place the fourth playback device 710 on the floor of the listening environment. An accelerometer may be used in playback devices to determine that they are at the correct orientation. If it is determined that they are not at the correct orientation, or not placed on a floor, based on a local ceiling height measurement indicating a ceiling height below a threshold, the user may be prompted to change the position. A user may use augmented reality to check that one or more of the playback devices are correctly positioned and/or oriented, and/or to make measurements of relative heights of devices or heights of the devices from a floor.

As described above in steps 604 and 612 of method 600, reflections off the ceiling 718 between two devices may be used to determine ceiling characteristics. In the example of FIG. 7, a reflection 728 may be between a playback device and the control device 712, or a reflection 730 may be between two playback devices. The reflections may be used to determine an average ceiling height between the two devices. Two reflections 728 between the third playback device 708 and the control device 712 are shown in FIG. 7, because the third playback device 708 may include multiple upward-firing transducers. A distance between two upward-firing transducers of the same playback device may also be used to determine a ceiling characteristic, according to embodiments.

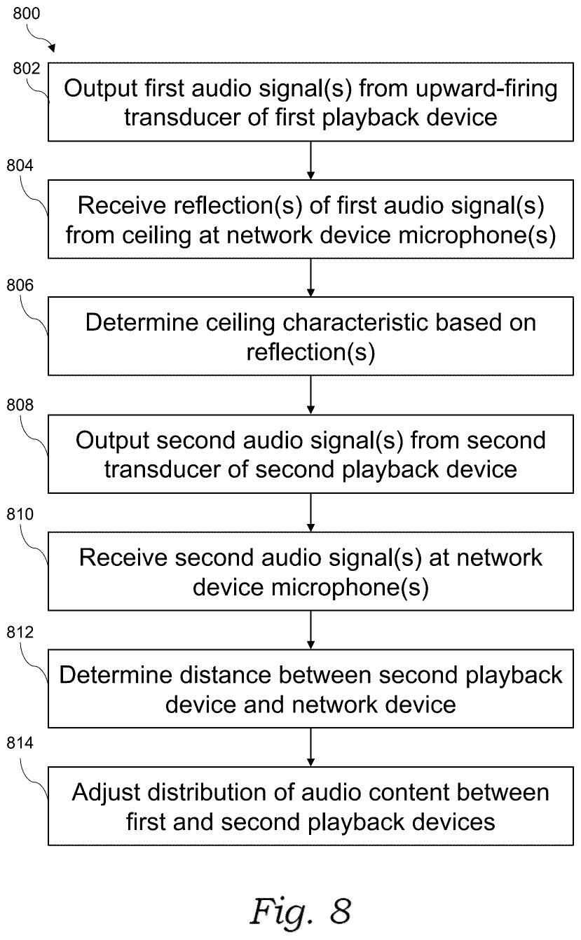

FIG. 8 is a flow chart summarizing a method 800 for adjusting audio playback based on a ceiling characteristic. The method 800 includes, at step 802, outputting, via a first upward-firing transducer in a first playback device in a listening environment, one or more first audio signals. At step 804, one or more microphones in the listening environment receives one or more reflection of the one or more first audio signals. The one or more microphones are provided at a network device. At step 806, based on the reflection, a ceiling characteristic may be determined. Steps 802 to 806 may be replaced by the steps of the method of FIG. 6 above. In some examples, a ceiling characteristic may be known from a previous performance of steps 802 to 806 or FIG. 6, so the known characteristic may be used instead of deriving it again.

At step 808, a second audio signal is output, via a second transducer in a second playback device in the listening environment. The second transducer and playback device may be different to the first playback device. The second transducer may be an upward-firing transducer or a horizontal-firing transducer. At step 810, the second audio signal is received at the one or more microphones. A distance between the second playback device and the network device may be determined at step 812.

Based on the determined distance, from step 812, and the ceiling characteristic determined in step 806, a distribution of audio content between the first playback device and the second playback device is adjusted at step 814. The distribution between the first and second playback devices and other playback devices may be adjusted.

Examples of how distribution of audio content may be adjusted will be described with reference to FIG. 7. In a first set of examples, the first and second playback devices of FIG. 8 correspond to the first and second playback devices 704 and 706 of FIG. 7. The ceiling characteristic is determined, as in step 806, based on the reflection 728 between the first playback device 704 and the control device 712, and the distance determined in step 812 corresponds to the distance 720 determined between the second playback device 706 and the control device 712.

The distance 720 and ceiling characteristic may be used to adjust an audio content distribution. For example, it may be determined that the first and second playback devices are at different heights or that the ceiling above them is uneven, and so audio output parameters of one or each playback device may be adjusted so that the audio output from the playback devices is correctly perceived by a listener at the listener location 716. As a result, the listening experience of the user can be optimized.

In some circumstances, a user may position the first playback device 704 in an unsuitable location, such as beneath a shelf, in a bookshelf or cabinet, or in a portion of the listening environment with restricted height, such as a cubby or nook. Such an unsuitable location may be determined based on the ceiling characteristic. The ceiling characteristic may indicate a particularly low ceiling height above the first playback device 704 or an anomalous ceiling characteristic may be determined. Based on an unsuitable location being determined, some of the audio content that may have previously been sent to the first playback device 704 may be redistributed to the second playback device 706, and/or may be output differently from the first playback device 704. Also, based on an unsuitable location being determined, some examples may additionally, or alternatively, provide an indication that the speaker is misplaced. Any such indication may be audible, such as a beep, tone or spoken announcement. The indication may also be visible, such as a light or indicator on the first device itself, or an indicator or message provided via an associated controller device, such as via a graphical user interface of the controller device. Providing such an indication may assist a user to relocate the device to a more suitable position.

Redistribution of audio content to the second playback device 706 may include altering a relative intensity of the output audio between the first and second playback devices. In some examples, because of the unsuitable location, the upward-firing transducer may be disabled at the first playback device 704, or its volume may be reduced. In some examples, a directionality of the upward-firing transducer may be changed to avoid a problematic ceiling portion. The second transducer may have its volume increased, it may be activated where previously it was not active, or it may be used to cancel the output of the upward-firing transducer. When operation of the first and/or the second playback device is changed, some examples may provide an indication that the operation has changed. The indication may be audible, such as a beep, tone or spoken announcement. The indication may also be visible, such as a light or indicator on the first device itself, or an indicator or message provided via an associated controller device, such as via a graphical user interface of the controller device. Providing such an indication may assist a user to understand how the position of the first playback device has resulted in an adjusted operation, so that they can make a more informed choice on whether to move or reposition the first playback device.

In some examples, the second transducer may be used to output a portion of the audio content intended for the upward-firing transducer. In other words, the first playback device 704 may not output some content, and instead that content may be redirected to the second playback device 706. If the second playback device includes an upward-firing transducer, as playback device 706 does, it may replicate the height audio using the upward-firing transducer, so that the listener perceives the height audio as originating from above. If the second playback device does not include an upward-firing transducer, e.g., where the second playback device is a device as described in relation to FIG. 2, then a horizontal-firing transducer may be used to output the portion of the height audio.

In other examples, the first and second playback devices 704, 706 may be in front of the listener location 716, relative to, for example, a screen or television. Audio content received at the first and second playback devices 704, 706 may include front and rear audio. The front audio may be output by a horizontal-firing transducer, e. g, at the second playback device 706, and the rear audio may be output by an upward-firing transducer, e.g., at the first playback device 704, based on the ceiling characteristic and the determined distance. Other distances, as shown and described in relation to FIG. 7 may also be determined and used to adjust the distribution of content, as in step 814.

In another example, the third playback device 708 may be positioned between the first playback device 704 and the second playback device 706, and those three devices may be positioned in front of the listener location, with respect to a screen or other focal point. Lateral audio may be distributed between the devices such that a central channel is reproduced by the third playback device 708 and left and right channels are reproduced by the second and first playback devices 706, 704 respectively. It may be determined, based on the distance measurement and/or one or more reflections, that a path from the third playback device 708 to the listener location 716 via the ceiling is shorter or more direct than a similar path from the first or second playback device 704, 706 to the listener location. It may be preferable to ensure that high frequencies arrive at the listener location more directly, so the distribution may be adjusted so that the third playback device 708 outputs higher frequencies than the first and second playback devices 704, 706.

In yet further examples, the first and second playback devices of the method 800 may correspond to the first playback device 704 and the fourth playback device 710. The fourth playback device 710 is a subwoofer configured to output low frequencies such as those less than around 200 Hz, or less than around 100 Hz. A listening environment mode may be caused by the low frequency output of the fourth playback device 710, due to its omnidirectionality. Knowledge of the ceiling characteristic may be used to allow such a listening environment mode, resonances, and/or other standing waves to be predicted. Audio content distribution may be adjusted to counteract such effects, either by adjusting the output of the subwoofer to reduce the mode or of the first playback device 704.

### V. Conclusion

The above discussions relating to playback devices, controller devices, playback zone configurations, and media content sources provide only some examples of operating environments within which functions and methods described below may be implemented. Other operating environments and/or configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software examples or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “example” means that a particular feature, structure, or characteristic described in connection with the example can be included in at least one example of an invention. The appearances of this phrase in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring examples of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

Examples are given the following clauses:

Clause 1. A media playback system comprising: a first upward-firing transducer in a first playback device; a first horizontal-firing transducer in the first playback device; one or more microphones that are horizontally spaced apart from the first upward-firing transducer; one or more processors; and memory storing instructions. The instructions, when executed by the one or more processors, cause the media playback system to: output, from the first upward-firing transducer, one or more first audio signals; receive, at the one or more microphones, a reflection of the one or more first audio signals from a ceiling of a listening environment in which the first playback device and the one or more microphones are positioned; output, from the first horizontal-firing transducer, one or more second audio signals; receive the one or more second audio signals at the one or more microphones; determine a distance between the first playback device and the one or more microphones based on the one or more second audio signals; and determine, based on the reflection of the one or more first audio signals and the distance between the first playback device and the one or more microphone, a ceiling characteristic.

Clause 2: The media playback system of clause 1, comprising a second upward-firing transducer, wherein the instructions, when executed by the one or more processors, cause the media playback system to: output, from the second upward-firing transducer, one or more third audio signals; receive, at the one or more microphones, a reflection of the one or more third audio signals from the ceiling; and determine the ceiling characteristic based on the reflection of the one or more third audio signals.

Clause 3: The media playback system of clause 2, comprising a second playback device that includes the second upward-firing transducer.

Clause 4: The media playback system of clause 3, comprising a second horizontal-firing transducer in the second playback device, and wherein the instructions, when executed by the one or more processors, cause the media playback system to: output, from the second horizontal-firing transducer, one or more fourth audio signals; receive the one or more fourth audio signals at the one or more microphones; determine a distance between the second playback device and the one or more microphones based on the one or more fourth audio signals; and determine the ceiling characteristic based on the distance between the second playback device and the one or more microphones.

Clause 5: The media playback system of clause 3, wherein the instructions, when executed by the one or more processors, cause the media playback system to: determine a distance between the first playback device and the second playback device; and determine the ceiling characteristic based on the distance between the first playback device and the second playback device.

Clause 6: The media playback system of any of clauses 1 to 5, comprising a first network device including a first microphone of the one or more microphones and a second network device including a second microphone of the one or more microphones, wherein the instructions, when executed by the one or more processors, cause the media playback system to: receive, at the first microphone, the reflection of the one or more first audio signals from the ceiling; receive, at the second microphone, a further reflection of the one or more first audio signals from the ceiling; and determine the ceiling characteristic based on the reflection and the further reflection of the one or more first audio signals.

Clause 7. The media playback system of any of clauses 1 to 6, wherein the first playback device comprises at least one further microphone, and wherein the instructions, when executed by the one or more processors, cause the media playback system to: receive, at the at least one further microphone of the first playback device, a further reflection of the one or more first audio signals; and determine, based on the further reflection of the one or more first audio signals, a local distance of the first playback device from the ceiling.

Clause 8. The media playback system of any of clauses 1 to 7, wherein at least one microphone of the one or more microphones has a predetermined height, and wherein the instructions, when executed by the one or more processors, cause the media playback system to determine the ceiling characteristic based on the predetermined height.

Clause 9. The media playback system of any of clauses 1 to 8, wherein the ceiling characteristic comprises at least one of: a distance; a shape; an absorption; a diffusion; a material; or a frequency response.

Clause 10. The media playback system of clause 9, wherein the ceiling characteristic comprises an average ceiling distance.

Clause 11. The media playback system of any of clauses 1 to 10, comprising a network device that includes the one or more microphones, wherein the network device and the first playback device are time-synchronized.

Clause 12. The media playback system of claim 1, wherein the instructions, when executed by the one or more processors, cause the media playback system to adjust, based on the ceiling characteristic, an audio output parameter for the first playback device.

Clause 13. A method comprising: outputting, from a first upward-firing transducer at a first playback device, one or more first audio signals; receiving, at one or more microphones that are horizontally spaced apart from the first upward-firing transducer, a reflection of the one or more first audio signal from a ceiling of a listening environment in which the first playback device and the one or more microphones are positioned; outputting, from a first horizontal-firing transducer at the first playback device, one or more second audio signals; receiving the at least one second audio signal at the one or more microphones; determining a distance between the first playback device and the one or more microphones based on the at least one second audio signal; and determining, based on the reflection of the one or more first audio signals and the distance between the first playback device and the one or more microphones, a ceiling characteristic.

Clause 14. The method of clause 13, comprising: outputting, from a second upward-firing transducer, one or more third audio signals; receiving, at the one or more microphones, a reflection of the one or more third audio signals from the ceiling; and determining the ceiling characteristic based on the reflection of the one or more third audio signals.

Clause 15. The method of clause 13 or 14, wherein a first network device includes a first microphone of the one or more microphones and a second network device includes a second microphone of the one or more microphones, and wherein the method comprises: receiving, at the first microphone, the reflection of the one or more first audio signals from the ceiling; receiving, at the second microphone, a further reflection of the one or more first audio signals from the ceiling; and determining the ceiling characteristic based on the reflection and the further reflection of the one or more first audio signals.

Clause 16. The method of claim 13, 14 or 15, wherein the first playback device comprises at least one microphone and wherein the method comprises: receiving, at the at least one microphone of the first playback device, a further reflection of the one or more first audio signals; and determining, based on the further reflection of the one or more first audio signals, a local distance of the first playback device from the ceiling.

Clause 17. The method of any of clauses 13 to 16, wherein at least one microphone of the one or more microphones has a predetermined height, and wherein the method comprises determining the ceiling characteristic based on the predetermined height.

Clause 18. The method of any of clauses 13 to 17, wherein the ceiling characteristic comprises at least one of: a distance; a shape; an absorption; a diffusion; a material; or a frequency response.

Clause 19. The method of any of clauses 13 to 18, comprising adjusting, based on the ceiling characteristic, an audio output parameter for the first playback device.

Clause 20. One or more tangible, non-transitory computer-readable media storing instructions that, when executed by one or more processors of a media playback system, cause the media playback system to perform operations comprising: outputting, from a first upward-firing transducer at a first playback device, one or more first audio signals; receiving, at one or more microphones that are horizontally spaced apart from the first upward-firing transducer, a reflection of the one or more first audio signal from a ceiling of a listening environment in which the first playback device and the one or more microphones are positioned; outputting, from a first horizontal-firing transducer at the first playback device, one or more second audio signals; receiving the one or more second audio signals at the one or more microphones; determining a distance between the first playback device and the one or more microphones based on the one or more second audio signals; and determining, based on the reflection of the one or more first audio signals and the distance between the first playback device and the one or more microphone, a ceiling characteristic.

Clause 21. A media playback system including a first playback device, a second playback device, and a network device in a listening environment, the media playback system comprising: a first transducer in the first playback device, wherein the first transducer is an upward-firing transducer; a second transducer in the second playback device; one or more microphones in the network device; one or more processors; and memory storing instructions. The instructions, when executed by the one or more processors, cause the media playback system to: output, via the first transducer, a first signal; output, via the second transducer, a second signal; receive, via the one or more microphones, (i) a reflection of the first signal and (ii) the second signal; determine, via the received reflection of the first signal, a ceiling characteristic of the listening environment; determine, via the received second signal, a first distance between the second playback device and the network device; and adjust a distribution of audio output between the first transducer and the second transducer based on (i) the ceiling characteristic and (ii) the first distance.

Clause 22. The media playback system of clause 21, wherein the instructions, when executed by the one or more processors, cause the media playback system to: determine, based on the ceiling characteristic, that the first transducer is at an unsuitable position within the listening environment; and adjust the distribution of audio output by adjusting a first audio output parameter of the first transducer based on determining that first transducer is at the unsuitable position.

Clause 23. The media playback system of clause 22, wherein the instructions, when executed by the one or more processors, cause the media playback system to determine that the first transducer is at the unsuitable position within the listening environment by at least one of: determining that the first transducer is directed towards a boundary of the listening environment other than the ceiling of the listening environment; or determining that the first transducer is less than a predetermined distance from at least a portion of the ceiling.

Clause 24. The media playback system of clause 22 or 23, wherein the instructions, when executed by the one or more processors, cause the media playback system to adjust the distribution of audio output by adjusting a second audio output parameter of the second transducer based on determining that first transducer is at the unsuitable position.

Clause 25. The media playback system of any of clauses 21 to 24, wherein the instructions, when executed by the one or more processors, cause the media playback system to adjust the distribution of audio output by at least one of: disabling the first transducer; reducing an audio output volume of the first transducer; or adjusting a directivity of the audio output from the first transducer.

Clause 26. The media playback of clauses 21 to 24, wherein the instructions, when executed by the one or more processors, cause the media playback system to adjust the distribution of audio output by at least one of: outputting at least a portion of audio content intended for the first transducer via the second transducer; increasing an audio output volume of the second transducer; or outputting an audio signal for cancelling at least part of the audio output of the first transducer.

Clause 27. The media playback of clause 26, wherein the second transducer is a horizontal-firing transducer, and wherein the instructions, when executed by the one or more processors, cause the media playback system to: receive audio output data comprising vertical audio content and horizontal audio content; and adjust the distribution of audio output by outputting, from the second transducer, the horizontal audio content and at least a portion of the vertical audio content.

Clause 28. The media playback system of any of clauses 21 to 27, wherein the second transducer is a horizontal-firing transducer, and wherein the instructions, when executed by the one or more processors, cause the media playback system to: receive audio output data comprising first audio content and second audio content, wherein the first audio content is for reproduction from a perceived position in front of a listener and the second audio content is for reproduction from a perceived position behind the listener; and adjust the distribution of audio output by: outputting, from the second transducer, at least a portion of the first audio content; and outputting, from the first transducer, at least a portion of the second audio content based on the ceiling characteristic.

Clause 29. The media playback system of clause 28, wherein the instructions, when executed by the one or more processors, cause the media playback system to: adjust the distribution of audio output by outputting, from the first transducer, an audio signal for cancelling at least part of the first audio content in the direction of the ceiling of the listening environment.

Clause 30. The media playback system of any of clauses 21 to 29, wherein the second transducer has an output including frequencies below 200 Hz, and wherein the instructions, when executed by the one or more processors, cause the media playback system to: adjust the distribution of audio output by outputting, from the first transducer, at least one audio signal to counteract a listening environment mode with the ceiling when the second transducer is operational.

Clause 31. The media playback system of any of clauses 21 to 30, wherein the second transducer has an output including frequencies below 200 Hz, and wherein the instructions, when executed by the one or more processors, cause the media playback system to: adjust the distribution of audio output by adjusting the output of the second transducer to attenuate one or more frequencies to counteract a listening environment mode with the ceiling.

Clause 32. The media playback system of any of clauses 21 to 31, wherein the second transducer is an upward-firing transducer, and wherein the instructions, when executed by the one or more processors, cause the media playback system to: determine, based on the ceiling characteristic, that a first path between the first transducer and a typical listener position via the ceiling is shorter than a second path between the second transducer and the typical listener position via the ceiling; and adjust the distribution of audio output between the first transducer and the second transducer.

Clause 33. A method comprising: outputting, via a first transducer in a first playback device in a listening environment, a first signal, wherein the first transducer is an upward-firing transducer; outputting, via a second transducer in a second playback device in the listening environment, a second signal; receiving, via one or more microphones in a network device in the listening environment, (i) a reflection of the first signal and (ii) the second signal; determining, via the received reflection of the first signal, a ceiling characteristic of the listening environment; determining, via the received second signal, a first distance between the second playback device and the network device; and adjusting a distribution of audio output between the first transducer and the second transducer based on (i) the ceiling characteristic and (ii) the first distance.

Clause 34. The method of clause 33 comprising: determining, based on the ceiling characteristic, that the first transducer is at an unsuitable position within the listening environment; and adjusting the distribution of audio output by adjusting a first audio output parameter of the first transducer based on determining that first transducer is at the unsuitable position.

Clause 35. The method of clause 33 or 34, wherein adjusting the distribution of audio output comprises at least one of: disabling the first transducer; reducing an audio output volume of the first transducer; or adjusting a directivity of the audio output from the first transducer.

Clause 36. The method of clause 33, 24 or 35 wherein adjusting the distribution of audio output comprises at least one of: outputting at least a portion of audio content intended for the first transducer via the second transducer; increasing an audio output volume of the second transducer; or outputting an audio signal for cancelling at least part of the audio output of the first transducer.

Clause 37. The method of any of clauses 33 to 36 wherein the second transducer is a horizontal-firing transducer, and wherein the method comprises: receiving audio output data comprising vertical audio content and horizontal audio content; and adjusting the distribution of audio output by outputting, from the second transducer, the horizontal audio content and at least a portion of the vertical audio content.

Clause 38. The method of any of clauses 33 to 37 wherein the second transducer is a horizontal-firing transducer, and wherein the method comprises: receiving audio output data comprising first audio content and second audio content, wherein the first audio content is for reproduction from a perceived position in front of a listener and the second audio content is for reproduction from a perceived position behind the listener; and adjusting the distribution of audio output by: outputting, from the second transducer, at least a portion of the first audio content; and outputting, from the first transducer, at least a portion of the second audio content based on the ceiling characteristic.

Clause 39. The method of clause 34, wherein the second transducer has an output including frequencies below 200 Hz, and wherein the method comprises: adjusting the distribution of audio output by at least one of: outputting, from the first transducer, at least one audio signal to counteract a listening environment mode with the ceiling when the second transducer is operational; or adjusting the output of the second transducer to attenuate one or more frequencies to counteract a listening environment mode with the ceiling.

Clause 40. One or more tangible, non-transitory computer-readable media storing instructions that, when executed by one or more processors of a media playback system, cause the media playback system to perform operations comprising: outputting, via a first transducer in a first playback device in a listening environment, a first signal, wherein the first transducer is an upward-firing transducer; outputting, via a second transducer in a second playback device in the listening environment, a second signal; receiving, via one or more microphones in a network device in the listening environment, (i) a reflection of the first signal and (ii) the second signal; determining, via the received reflection of the first signal, a ceiling characteristic of the listening environment; determining, via the received second signal, a first distance between the second playback device and the network device; and adjusting a distribution of audio output between the first transducer and the second transducer based on (i) the ceiling characteristic and (ii) the first distance.

1. A method comprising:
outputting, via a first transducer in a first playback device in a listening environment, a first signal, wherein the first transducer is an upward-firing transducer;
outputting, via a second transducer in a second playback device in the listening environment, a second signal;
determining, based on a first microphone signal corresponding to a received reflection of the first signal received via one or more microphones of a network device, a ceiling characteristic of a ceiling of the listening environment;
determining, based on a second microphone signal corresponding to receiving the second signal by the one or more microphones, a first distance between the second playback device and the network device; and
adjusting a distribution of audio output between the first transducer and the second transducer based on (i) the ceiling characteristic and (ii) the first distance.

2. The method of claim 1, further comprising, when the determined ceiling characteristic indicates that the first transducer is at an unsuitable position within the listening environment, adjusting the distribution of audio output by adjusting a first audio output parameter of the first transducer.

3. The method of claim 2, further comprising determining that the ceiling characteristic indicates that the first transducer is at an unsuitable position within the listening environment when it is determined that the first transducer is at least one of:
directed toward a boundary of the listening environment other than the ceiling; or
less than a predetermined distance from at least a portion of the ceiling.

4. The method of claim 2, wherein adjusting the distribution of audio output comprises, based on determining that the first transducer is at the unsuitable position, adjusting a second audio output parameter of the second transducer.

5. The method of claim 2, wherein adjusting the distribution of audio output comprises, based on determining that the first transducer is at the unsuitable position, at least one of:
disabling the first transducer;
reducing an audio output volume of the first transducer; or
adjusting a directivity of the audio output from the first transducer.

6. The method of claim 1, wherein adjusting the distribution of audio output comprises at least one of:
disabling the first transducer;
reducing an audio output volume of the first transducer; or
adjusting a directivity of the audio output from the first transducer.

7. The method of claim 1, wherein adjusting the distribution of audio output comprises at least one of:
outputting at least a portion of audio content intended for the first transducer via the second transducer;
increasing an audio output volume of the second transducer; or
outputting an audio signal for cancelling at least part of the audio output of the first transducer.

8. The method of claim 1, wherein the second transducer is an upward-firing transducer, wherein adjusting the distribution of audio content comprises, when it is determined, based on the ceiling characteristic, that a first path between the first transducer and a typical listener position via the ceiling is shorter than a second path between the second transducer and the typical listener position via the ceiling, adjusting the distribution of audio output such that the audio output of the first transducer includes higher frequencies than the audio output from the second transducer.

9. The method of claim 1, wherein the second transducer is a horizontal-firing transducer and wherein adjusting the distribution of audio output comprises, when received audio output data comprises vertical audio content and horizontal audio content:
outputting, from the second transducer:
horizontal audio content of received audio output data comprising vertical and horizontal audio content, and
at least a portion of the vertical audio content.

10. The method of claim 1, wherein the second transducer is a horizontal-firing transducer and wherein adjuring the distribution of audio output comprises, when received audio output data comprises first audio content for reproduction from a perceived position in front of a listener and second audio content for reproduction from a perceived position behind the listener:
outputting, from the second transducer, at least a portion of the first audio content; and
outputting, from the first transducer, at least a portion of the second audio content, based on the ceiling characteristic.

11. The method of one of claim 1, wherein adjusting the distribution of audio output comprises, when the second transducer has an output including frequencies below 200 Hz, at least one of:
outputting, from the first transducer, at least one audio signal to counteract a listening environment mode with the ceiling when the second transducer is operational; or
adjusting the output of the second transducer to attenuate one or more frequencies to counteract a listening environment mode with the ceiling.

12. One or more tangible, non-transitory computer-readable media storing instructions that, when executed by one or more processors of a media playback system, cause the media playback system to:
output, via a first transducer in a first playback device in a listening environment, a first signal, wherein the first transducer is an upward-firing transducer;
output, via a second transducer in a second playback device in the listening environment, a second signal;
determine, based on a first microphone signal corresponding to a received reflection of the first signal received via one or more microphones of a network device, a ceiling characteristic of a ceiling of the listening environment;
determine, based on a second microphone signal corresponding to a receiving the second signal via the one or more microphones, a first distance between the second playback device and the network device; and
adjust a distribution of audio output between the first transducer and the second transducer based on (i) the ceiling characteristic and (ii) the first distance.

13. The computer readable media of claim 12, wherein the instructions, when executed by the one or more processors cause the media playback system to adjust the distribution of audio output by at least one of:
disabling the first transducer;
reducing an audio output volume of the first transducer; or
adjusting a directivity of the audio output from the first transducer.

14. The computer readable media of claim 12, wherein the instructions, when executed by the one or more processors cause the media playback system to adjust the distribution of audio output by at least one of:
outputting at least a portion of audio content intended for the first transducer via the second transducer;
increasing an audio output volume of the second transducer; or
outputting an audio signal for cancelling at least part of the audio output of the first transducer.

15. The computer readable media of claim 12, wherein the second transducer is an upward-firing transducer and wherein the instructions, when executed by the one or more processors, cause the media playback system to adjust the distribution of audio output such that the audio output of the first transducer includes higher frequencies than the audio output from the second transducer when it is determined, based on the ceiling characteristic, that a first path between the first transducer and a typical listener position via the ceiling is shorter than a second path between the second transducer and the typical listener position via the ceiling.

16. The computer readable media of claim 12, wherein the second transducer is a horizontal-firing transducer and wherein the instructions, when executed by the one or more processors, cause the media playback system to adjust the distribution of audio output by outputting, from the second transducer, horizontal audio content and at least a portion of vertical audio content of received audio output data comprising vertical and horizontal audio content, when received audio output data comprises vertical audio content and horizontal audio content.

17. A media playback system including a first playback device, a second playback device, and a network device in a listening environment, the media playback system comprising:
a first transducer in the first playback device, wherein the first transducer is an upward-firing transducer;
a second transducer in the second playback device;
one or more microphones in the network device; and
one or more processors configured to cause the media playback system to:
output, via a first transducer in a first playback device in a listening environment, a first signal, wherein the first transducer is an upward-firing transducer;
output, via a second transducer in a second playback device in the listening environment, a second signal;
determine, based on a first microphone signal corresponding to a received reflection of the first signal received via one or more microphones of a network device, a ceiling characteristic of a ceiling of the listening environment;
determine, based on a second microphone signal corresponding to receiving the second signal by the one or more microphones, a first distance between the second playback device and the network device; and
adjust a distribution of audio output between the first transducer and the second transducer based on (i) the ceiling characteristic and (ii) the first distance.

18. The media playback system of claim 17, wherein the one or more processors are configured to cause the media playback system to adjust the distribution of audio output by at least one of:
disabling the first transducer;
reducing an audio output volume of the first transducer; or
adjusting a directivity of the audio output from the first transducer.

19. The media playback system of claim 17, wherein the one or more processors are configured to cause the media playback system to adjust the distribution of audio output by at least one of:
outputting at least a portion of audio content intended for the first transducer via the second transducer;
increasing an audio output volume of the second transducer; or
outputting an audio signal for cancelling at least part of the audio output of the first transducer.

20. The media playback system of claim 17, wherein the second transducer is an upward-firing transducer, and wherein the one or more processors are configured to cause the media playback system to adjust the distribution of audio output such that the audio output of the first transducer includes higher frequencies than the audio output from the second transducer when it is determined, based on the ceiling characteristic, that a first path between the first transducer and a typical listener position via the ceiling is shorter than a second path between the second transducer and the typical listener position via the ceiling.
